(19) United States
(12) Patent Application Publication
(10) Pub. No.: US 2009/0225867 A1
(43) Pub. Date: Sep. 10, 2009

(54) METHODS AND APPARATUS FOR PICTURE ACCESS

(76) Inventor: Kun-Bin Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/043,134

(22) Filed: Mar. 6, 2008

(51) Int. Cl. H04N 7/26

(52) U.S. Cl. 375/240.25; 375/E07.027

(57) ABSTRACT

A method for picture access, includes: during a period of time, detecting utilization statuses of reference data, wherein the reference data is capable of being utilized for picture decoding; and according to the detected utilization statuses, determining whether/how to load at least a portion of reference data of a frame into a local buffer.

### BACKGROUND

The present invention relates to motion compensation for multiple reference frame architecture, and more particularly, to methods and apparatus for picture access.

Regarding multiple reference frame architecture, for example, an apparatus complying with H.264 specifications, some problems such as complicated memory access behavior and a high memory access rate of a main memory are introduced while multi-frame motion compensation is performed, where the main memory can be a dynamic random access memory (DRAM) accessed by a processor. Typically, the processor and the main memory are respectively positioned in different chips within a decoder, so the memory bandwidth of the main memory may be insufficient due to the complicated memory access behavior and/or the high memory access rate.

According to the related art, some suggestions with regard to data organization in the main memory (e.g. the DRAM) are proposed in order to solve or alleviate the problems mentioned above. For example, a decoder divides each block into three sections and stores each section into two DRAM banks. Another example suggests the decoder groups several blocks as a block set, in order to minimize the number of page miss while accessing the main memory. According to another suggestion, different slices can be stored into different DRAM banks for motion compensation.

However, the performance of architecture implemented with one of the aforementioned suggestions is typically degraded due to some native characteristics of the multi-frame motion compensation. For example, referring to a situation shown in FIG. 1, reference data of a macroblock (MB) may be derived from multiple frames. In addition, more motion vectors and more Intra information are involved in contrast to single frame motion compensation. Thus, a great burden of inter-chip memory access may still be encountered.

### SUMMARY

It is therefore an objective of the claimed invention to provide methods and apparatus for picture access to solve the above-mentioned problems of high memory access rate and complicated memory accessing behavior while conducting motion compensation with multiple reference frames.

An exemplary embodiment of a method for picture access comprises: during a period of time, detecting utilization statuses of reference data, wherein the reference data is capable of being utilized for picture decoding; and according to the detected utilization statuses, determining whether/how to load at least a portion of reference data of a frame into a local buffer.

An exemplary embodiment of an apparatus for picture access comprises: a main memory for temporarily storing data; and a processor, coupled to the main memory. The processor comprises: a preload buffer for preloading data for the processor; and a core circuit, coupled to the preload buffer, for performing operations of the processor. During a period of time, the processor detects utilization statuses of reference data, and the reference data is capable of being utilized for picture decoding. According to the detected utilization statuses, the processor determines whether/how to load at least a portion of reference data of a frame into the preload buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a situation where multi-frame motion compensation is performed.

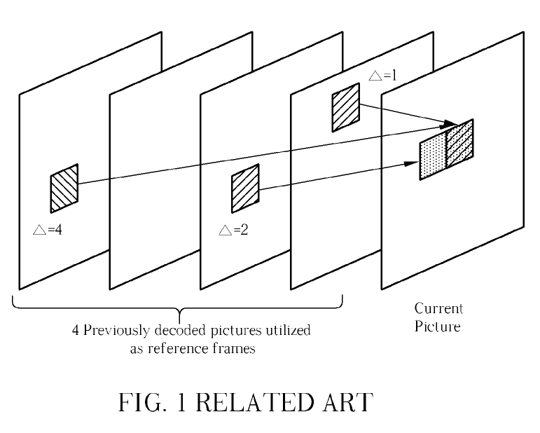

FIG. 2 is a diagram illustrating an apparatus for picture access according to one embodiment of the present invention.

FIG. 3 is a flowchart of a method for picture access according to a first embodiment of the present invention.

FIG. 4 is a flowchart of a method for picture access according to another embodiment of the present invention.

FIG. 5 is a flowchart of a method for picture access according to another embodiment of the present invention.

FIG. 6 illustrates a situation where multi-frame motion compensation is performed according to the embodiment shown in FIG. 5.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

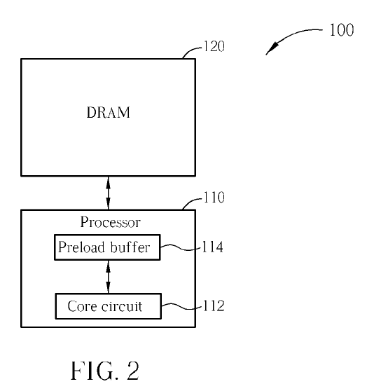

Please refer to FIG. 2. FIG. 2 is a diagram of an apparatus 100 for picture access according to one embodiment of the present invention. The apparatus 100 comprises a processor 110 and a main memory such as a dynamic random access memory (DRAM) 120, where the main memory is an external memory for the processor 110. This apparatus 100 is typically a video decoder or a portion of the video decoder, capable of executing multi-frame motion compensation. In addition, the processor 110 comprises a core circuit 112 and at least one preload buffer 114, where the preload buffer 114 is a local buffer for the processor 110, and comprises at least one logical/physical buffer such as static random access memory (SRAM) or registers.

According to this embodiment, the core circuit 112 is utilized for performing operations of the processor 110, where the preload buffer 114, which is embedded within the processor 110, can be implemented with at least one SRAM. In addition, the preload buffer 114 can be utilized for preloading data (e.g. data of a picture to be decoded in the future) for the processor 110, so the processor 110 may utilize the data in the preload buffer 114 as look-ahead information. By utilizing the look-ahead information, the processor 110 may determine data accessing behavior of the main memory (i.e. the DRAM 120 in this embodiment) when decoding a current picture. In practice, the preload buffer 114 may be divided into a plurality of logical buffers.

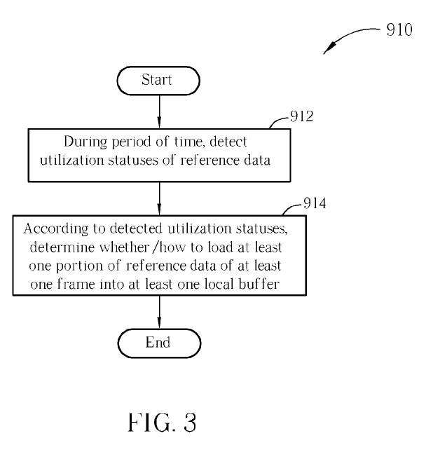

FIG. 3 is a flowchart of a method 910 for picture access according to a first embodiment of the present invention. The method 910 can be implemented by utilizing the apparatus 100 shown in FIG. 2, and can further be described as follows.

In Step 912, during a period of time, the processor 110 detects utilization statuses of reference data, where the reference data is capable of being utilized for picture decoding.

In Step 914, according to the detected utilization statuses, the processor 110 determines whether/how to load at least a portion of reference data of at least one frame from the main memory (i.e. the DRAM 120 in this embodiment) into at least one local buffer (i.e. the preload buffer 114 in this embodiment), where each frame carries image data corresponding to a picture in this embodiment.

More particularly, according to different implementation choices of this embodiment, the utilization statuses may represent reference frame information and/or motion vector (MV) usage information. For example, the utilization statuses may comprise ranges of a plurality of MVs derived from a decoding phase of picture decoding, and/or the utilization statuses may comprise information indicating which frame is utilized as a reference frame of a current picture being decoded.

Please note that, in this embodiment, the reference frame information may comprise an index representing a macroblock (MB), several MBs, a MB row, or the whole frame as needed in different situations. In addition, the period of time mentioned above may correspond to a certain amount of MB(s), MB row(s), or frame(s) according to different implementation choices. Based on the utilization statuses, in Step 914, the processor 110 may determine which frame(s) out of a plurality of candidate reference frames should be considered, and which frame(s) out of the candidate reference frames should be omitted. Thus, according to the utilization statuses, the processor 110 may determine a simplified memory access behavior for accessing data stored in the main memory, i.e. the DRAM 120 in this embodiment.

According to the architecture shown in FIG. 2, with the method 910 applied, the processor 110 may determine which portion of data in the main memory (e.g. the DRAM 120) should be loaded into the local buffer (e.g. the preload buffer 114), so the memory bandwidth between the processor 110 and the DRAM 120 can be optimized in different degree of simplification in accordance with the utilization statuses. Therefore, in a situation where loading a portion of reference data from the main memory into the local buffer corresponds to inter-chip memory access, i.e. the situation where the processor 110 and the DRAM 120 are positioned in different chips, a related art problem such as insufficient bandwidth between chips will be alleviated.

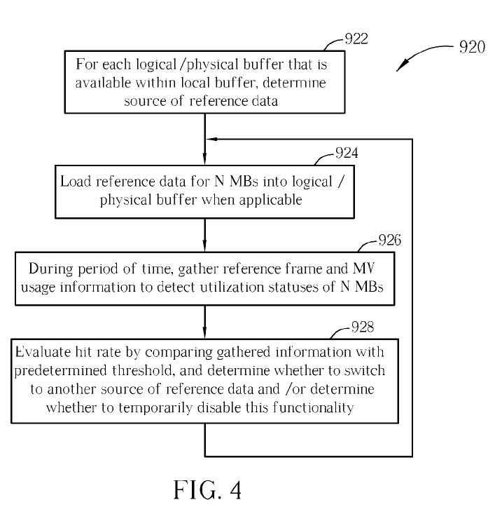

FIG. 4 is a flowchart of a method 920 for picture access according to another embodiment of the present invention, where this embodiment is a variation of the embodiment shown in FIG. 3. According to this variation, whether/how to load the portion of reference data into the local buffer is dynamically determined according to the detected utilization statuses.

In Step 922, for each logical/physical buffer that is available within the local buffer (e.g. the preload buffer 114), the processor 110 determines a source of reference data. Please note that the source typically represents a reference frame. More specifically, in this variation, the processor 110 determines which frame(s) out of a plurality of candidate reference frames is the frame(s) whose data is to be retrieved as reference data for decoding a current picture. An example of the candidate reference frames is the three I/P frames that are closest to the current picture. In this variation, the reference data may be utilized for decoding at least one MB of the current picture, for example, for decoding N MBs of the current picture. Assuming the apparatus 100 executes method 920 to dynamically evaluate the hit rate or adjust the reference data source every N MBs.

In Step 924, the processor 110 loads reference data for N MBs into the logical/physical buffer when applicable.

In Step 926, during a period of time, that is when the processor 110 gathers reference frame and MV usage information to detect the utilization statuses of the N MBs.

In Step 928, the processor 110 evaluates the hit rate by comparing the gathered information with a predetermined threshold, and determines whether to switch to another source of reference data and/or determines whether to temporarily disable this functionality (e.g. loading reference data). In some embodiments, the other source of reference data represents another reference frame or another set of reference frames. After Step 928 is executed, Step 924 can be re-entered if needed.

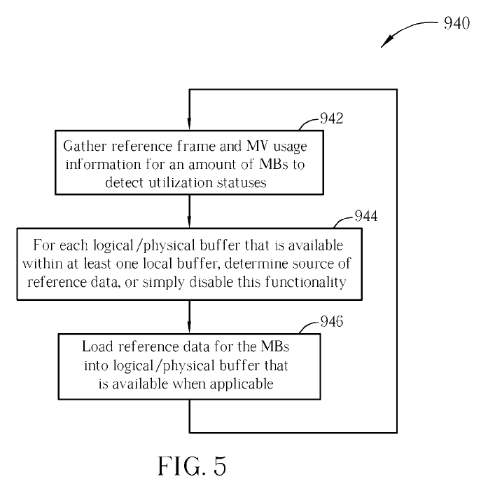

FIG. 5 is a flowchart of a method 940 for picture access according to another embodiment of the present invention, where this embodiment is another variation of the embodiment shown in FIG. 3, and is also a variation of the embodiment shown in FIG. 4. In this variation, the utilization statuses can be derived according to at least a portion of look-ahead information.

In Step 942, the processor 110 gathers reference frame and MV usage information for an amount of MBs to detect the utilization statuses. This step is varied from Step 912 mentioned above. However, the reference frame and MV usage information in this variation may comprise information corresponding to a picture to be decoded in the future, which is a look-ahead decoding aspect. Thus, the utilization statuses are derived from at least a portion of look-ahead information.

In Step 944, for each logical/physical buffer that is available within the at least one local buffer (e.g. the preload buffer 114), the processor 110 may determine a source of reference data or simply disable this functionality (e.g. determining the source for loading reference data). Please note that the source typically indicates the reference frame(s) of which the reference data is obtaining from. This step is varied from Step 914 mentioned above, and is also varied from Step 922 shown in FIG. 4.

In Step 946, the processor 110 loads reference data for the MBs into the logical/physical buffer when applicable. This step also varied from Step 924 shown in FIG. 4. After Step 946 is executed, Step 942 can be re-entered if needed. Similar descriptions are not repeated in detail for this variation.

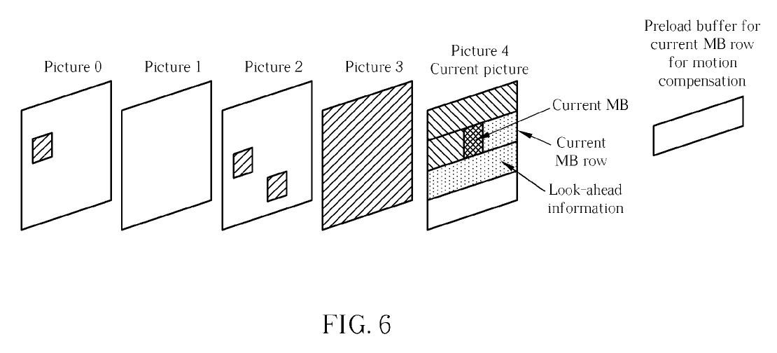

FIG. 6 illustrates a situation where multi-frame motion compensation is performed according to the embodiment shown in FIG. 5, where the preload buffer mentioned in FIG. 6 is within the preload buffer 114 shown in FIG. 2. Please note that, as shown in FIG. 6, some reference data can be preloaded before a current MB is completely reconstructed. According to this embodiment, if reference data from different reference frames for decoding the one or more MBs is closely positioned in the main memory, the reference data can be retrieved from the main memory even the respective values of MVs are greater than the predetermined threshold.

According to another embodiment, which is also a variation of the first embodiment, operations of delayed and grouped motion compensation (MC) execution(s) can be applied to Step 914. For example, partially decoded data can be derived while deriving the look-ahead information mentioned above, and some data accessing or motion compensation operations corresponding to the partially decoded data can be delayed for a while in order to be performed all together.

According to another variation, the slice type of the frame (e.g. slice types such as I, P, or B) can be one of the factors considered in the flow of loading reference data. For an I slice, statistically analysis of reference frame and MV usage information can be disabled in some embodiments. In addition, for P/B slices, regarding the reference direction(s), some logical buffers within the preload buffer 114 can be re-grouped or partitioned. In addition, a quantization parameter (QP) utilized in a decoding process may also be considered while detecting the utilization statuses since the QP may correspond to data arrangement in the main memory. For example, a search range can be diminished if QP value is greater than a preset threshold. Additionally, the amount of reference data loaded from the memory to the preload buffer can be one/several MB(s), one/several MB row(s), or one/several slice(s). The picture accessing methods and apparatuses of this invention are applicable to both moving pictures and static pictures. In some embodiments, methods of accessing at least a portion of a single picture are dependent on the utilization statuses used for picture decoding.

It should be noted that the present invention can also be applied to Intra prediction. In this situation, the reference frame is substantially the same frame that comprises the current MB. According to current H.264 standards, no MV information is required for Intra prediction. In contrast to this, when applying the present invention to Intra prediction, the MV for Intra prediction can be considered to be zero. In the future, some new standards may be introduced according to the teachings or suggestions of the present invention, where data of an MB far from the current MB may be utilized for performing Intra prediction, and some MV-like information can be utilized for Intra prediction.

Embodiments of the present invention observe utilization status for a period of time, and determine a way to load reference data into a local preload buffer. In contrast to the related art, the present invention methods and apparatus may achieve the goal of reducing a memory access rate of a main memory.

It is another advantage of some embodiments of the claimed invention that, the memory access behavior has been simplified when dealing with multi-frame motion compensation.

Those skilled in the art will readily observe that numerous modifications and alterations of the device and method may be made while retaining the teachings of the invention.

What is claimed is:

1. A method for picture access, comprising:
during a period of time, detecting utilization statuses of reference data, wherein the reference data is capable of being utilized for picture decoding; and
according to the detected utilization statuses, determining whether/how to load at least a portion of reference data of a frame into a local buffer.

2. The method of claim 1, wherein the period of time corresponds to a number of macroblock(s) (MB), MB row(s), or frame(s).

3. The method of claim 1, wherein the step of detecting the utilization statuses of the reference data further comprises:
detecting ranges of a plurality of motion vectors (MVs) derived from a decoding phase of picture decoding.

4. The method of claim 1, wherein the step of determining whether/how to load the portion of reference data into the local buffer further comprises:
determining whether/how to load the portion of reference data from a main memory into the local buffer.

5. The method of claim 4, wherein the step of determining whether/how to load the portion of reference data into the local buffer further comprises:
determining which portion of data in the main memory should be loaded into the local buffer.

6. The method of claim 4, wherein the main memory is a dynamic random access memory (DRAM), and the local buffer is a static random access memory (SRAM).

7. The method of claim 1, wherein in the step of determining whether/how to load the portion of reference data into the local buffer, loading the portion of reference data into the local buffer corresponds to inter-chip memory access.

8. The method of claim 1, wherein whether/how to load the portion of reference data into the local buffer is dynamically determined according to the detected utilization statuses.

9. The method of claim 8, wherein the step of determining whether/how to load the portion of reference data into the local buffer further comprises:
for each logical/physical buffer that is available within the at least one local buffer, determining a source of reference data, wherein the source indicates at least a reference frame;
wherein the method further comprises:
loading reference data for a plurality of macroblocks (MBs) into the logical/physical buffer when applicable.

10. The method of claim 9, wherein the step of detecting the utilization statuses of the reference data further comprises:
during a period of time, gathering reference frame and motion vector (MV) usage information for statistical analysis on utilization statuses.

11. The method of claim 10, wherein the step of determining whether/how to load the portion of reference data into the local buffer further comprises:
comparing the gathered information with a predetermined threshold to determine whether to switch to another source of reference data.

12. The method of claim 10, wherein the step of determining whether/how to load the portion of reference data into the local buffer further comprises:
comparing the gathered information with a predetermined threshold to determine whether to temporarily disable loading reference data.

13. The method of claim 1, wherein the utilization statuses are derived according to at least a portion of look-ahead information.

14. The method of claim 13, wherein the step of detecting the utilization statuses of the reference data further comprises:
gathering reference frame and motion vector (MV) usage information for an amount of macroblocks (MBs) for statistical analysis.

15. The method of claim 14, wherein the step of determining whether/how to load the portion of reference data into the local buffer further comprises:
for each logical/physical buffer that is available within the local buffer, determining a source of reference data, wherein the source indicates at least a reference frame;
wherein the method further comprises:
loading reference data for the MBs into the logical/physical buffer that is available when applicable.

16. The method of claim 15, further comprising:
Based on the utilization statistics of the statistical analysis, disabling determining the source; and/or
disabling loading reference data for the MBs into the logical/physical buffer.

17. The method of claim 1, wherein the step of determining whether/how to load the portion of reference data into the local buffer further comprises:
delaying and grouping motion compensation (MC) executions.

18. An apparatus for picture access, comprising:
a main memory for temporarily storing data; and
a processor, coupled to the main memory, the processor comprising:
a preload buffer for preloading data for the processor; and
a core circuit, coupled to the preload buffer, for performing operations of the processor;
wherein during a period of time, the processor detects utilization statuses of reference data, and the reference data is capable of being utilized for picture decoding;
wherein according to the detected utilization statuses, the processor determines whether/how to load at least a portion of reference data of a frame into the preload buffer.

19. The apparatus of claim 18, wherein the main memory is a dynamic random access memory (DRAM), and the preload buffer comprises a static random access memory (SRAM).

20. The apparatus of claim 18, wherein the processor determines which portion of data in the main memory should be loaded into the preload buffer.
